(19) United States
(12) Patent Application Publication
(10) Pub. No.: US 2020/0204991 A1
(43) Pub. Date: Jun. 25, 2020

(54) MEMORY DEVICE AND MANAGED MEMORY SYSTEM WITH WIRELESS DEBUG COMMUNICATION PORT AND METHODS FOR OPERATING THE SAME

(71) Applicant: Micron Technology, Inc., Boise, ID (US)

(72) Inventors: Jonathan S. PARRY, Boise, ID (US); Robert W. STRONG, Folsom, CA (US)

(21) Appl. No.: 16/231,267

(22) Filed: Dec. 21, 2018

(51) Int. Cl. H04W 12/06; H04W 12/04; H04L 29/06; H04L 9/08

(52) U.S. Cl. CPC H04W 12/06; H04L 9/0819; H04L 63/0876; H04W 12/0403

(57) ABSTRACT

A memory device implements a method of communication over a wireless medium utilizing an antenna embedded in the memory device. The memory device includes a wireless component that authenticates an external device by verifying a credential structure received from the external device over the wireless medium, responds to a request for a secure communication channel from the external device with a symmetric key, and establishes the secure communication channel with the debugging device over the wireless medium, and servicing requests from the external device to access debugging, testing, and diagnostics data of the memory device.

### TECHNICAL FIELD

The present disclosure generally relates to memory device debugging, and more specifically, relates to a method and system for wireless memory device communication to enable debugging, diagnostics, testing, control and configuration.

### BACKGROUND ART

A memory subsystem can be a storage system, such as a solid-state drive (SSD), and can include one or more memory components that store data. The memory components can be, for example, non-volatile memory components and volatile memory components. In general, a host system can utilize a memory subsystem to store data at the memory components and to retrieve data from the memory components.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory subsystem in accordance with some embodiments of the present disclosure.

FIG. 2A is a diagram of an example of an antenna etched in a redistribution layer (RDL) on a media component where a security controller is separate from a wireless controller.

FIG. 2B is a diagram of an example of an antenna etched in an RDL on a media component where a security controller is integrated with a wireless controller.

FIG. 2C is a diagram of one example of an antenna etched in an RDL on a controller.

FIG. 2D is a diagram of one example of an antenna placed on a substrate.

FIG. 2E is a diagram of one example of an antenna placed on a memory component and connected with a through silicon via (TSV).

FIG. 2F is a diagram of one example of an antenna on a memory component stack with a controller.

FIGS. 3A and 3B are a flow diagram of an example method to establish secure communication between a debugging device a wireless component in accordance with some embodiments of the present disclosure.

FIG. 4 is a block diagram of an example computer system in which embodiments of the present disclosure may operate.

### DETAILED DESCRIPTION

Aspects of the present disclosure are directed to providing a wireless debugging communication port in a memory subsystem. A memory subsystem is also hereinafter referred to as a “memory device.” An example of a memory subsystem is a memory module that is connected to a central processing unit (CPU) via a memory bus. Examples of memory modules include a dual in-line memory module (DIMM), a small outline DIMM (SO-DIMM), a non-volatile dual in-line memory module (NVDIMM), etc. Another example of a memory subsystem is a storage device that is connected to the central processing unit (CPU) via a peripheral interconnect (e.g., an input/output bus, a storage area network, etc.). Examples of storage devices include a solid-state drive (SSD), a flash drive, a universal serial bus (USB) flash drive, and a hard disk drive (HDD). In some embodiments, the memory subsystem is a hybrid memory/storage subsystem. In general, a host system can utilize a memory subsystem that includes one or more memory components. The host system can provide data to be stored at the memory subsystem and can request data to be retrieved from the memory subsystem.

Memory devices are integrated circuits that are packaged to be connected with other electronic devices. A ball grid array (BGA) is common packaging type used for integrated circuits. Manufacturers of integrated circuits use BGA packaging to permanently mount devices such as memory devices to circuit boards and to interface the packaged integrated circuits with the circuit boards. The circuit boards provide connectivity with other similarly mounted integrated circuits like microprocessors. In BGA packaging one face of the package is covered with pads that can be soldered to the circuit board. The embodiments can utilize BGA packaging as well as other types of packaging such as stacked BGA, package on package (POP), multi-chip packages (MCP), three-dimensional stacked memory (e.g., high bandwidth memory) and similar packages. These packages and technologies can have limited pin, ball or similar interconnect availability. For sake of clarity, the embodiments are primarily described with relation to BGA, but one skilled in the art would understand that the principles and processes described herein are also applicable to other packaging types.

Packaged integrated circuits utilized in mobile products, e.g., smartphones, are shrinking over time. For example, BGA packaged integrated circuits are getting smaller and the pads of the BGA are more tightly packed together and have a finer pitch. Some of the pads of the BGA are utilized for debugging. These pads are referred to as test pads. Joint Test Action Group (JTAG) ports and similar debugging ports are tied to these test pads of the BGA. A user or developer utilizes a JTAG port or similar port of an integrated circuit to debug a failure or to obtain operational information about the integrated circuit. However, physical access to debug an integrated circuit in mobile devices is limited by the size of the mobile devices and the packaging as well as the density of the BGA. In addition, test pads tied to physical debug ports provide security risks of unauthorized access to the integrated circuit and data stored therein.

Aspects of the present disclosure address the above and other deficiencies by providing a wireless communication component in an integrated circuit packaging such as in a memory device. An antenna for the wireless communication component can be embedded into the memory device or the packaging of the memory device to enable the wireless communication. A memory controller of the memory device includes a JTAG interface for a JTAG port. The JTAG port can be replaced with logic to implement a wireless communication port. The wireless communication port can connect to the antenna in the memory device or in the packaging. A manufacturer can add a wireless component to the memory device to enable any wireless communication protocol including radio frequency identification (RFID), Bluetooth, or similar short-range wireless communication protocols. The wireless communication component can support communication with multiple integrated circuits for debugging, diagnostics and similar functions. The wireless component can support a secured handshaking process to prevent unauthorized access to the memory device. A manufacturer can utilize a memory device with the wireless component in mobile devices where there is limited or no practical physical access to the memory device. In addition, the memory device with the wireless component can reduce the number of test pads that are needed thereby freeing space in the BGA for other pads.

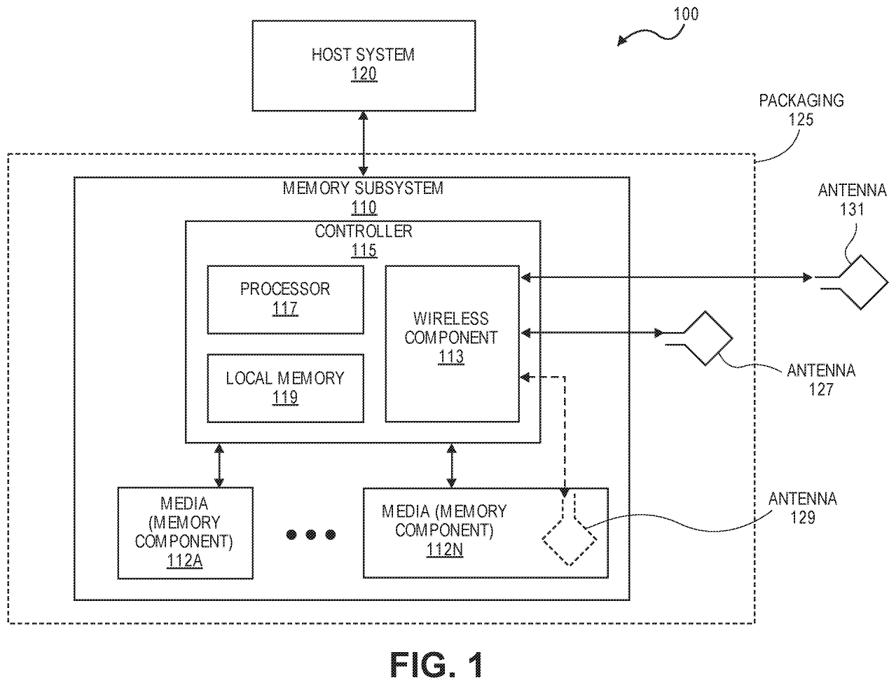

FIG. 1 illustrates an example computing environment 100 that includes a memory subsystem 110 in accordance with some embodiments of the present disclosure. The memory subsystem 110 can include media, such as memory components 112A to 112N. The memory components 112A to 112N can be volatile memory components, non-volatile memory components, or a combination of such. In some embodiments, the memory subsystem 110 is a storage system. An example of a storage system is an SSD. In some embodiments, the memory subsystem 110 is a hybrid memory/storage subsystem. In general, the computing environment 100 can include a host system 120 that uses the memory subsystem 110. For example, the host system 120 can write data to the memory subsystem 110 and read data from the memory subsystem 110.

The host system 120 can be a computing device such as a desktop computer, laptop computer, network server, mobile device, or similar computing device that includes a memory and a processing device. The host system 120 can include or be coupled to the memory subsystem 110 so that the host system 120 can read data from or write data to the memory subsystem 110. The host system 120 can be coupled to the memory subsystem 110 via a physical host interface. As used herein, “coupled to” generally refers to a connection between components, which can be an indirect communicative connection or direct communicative connection (e.g., without intervening components), whether wired or wireless, including connections such as electrical, optical, magnetic, etc. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory subsystem 110. The host system 120 can further utilize an NVM Express (NVMe) interface to access the memory components 112A to 112N when the memory subsystem 110 is coupled with the host system 120 by the PCIe interface. The physical host interface can provide an interface for passing control, address, data, and other signals between the memory subsystem 110 and the host system 120.

The memory components 112A to 112N can include any combination of the different types of non-volatile memory components and/or volatile memory components. An example of non-volatile memory components includes a negative-and (NAND) type flash memory. Each of the memory components 112A to 112N can include one or more arrays of memory cells such as single level cells (SLCs) or multi-level cells (MLCs) (e.g., triple level cells (TLCs) or quad-level cells (QLCs)). In some embodiments, a particular memory component can include both an SLC portion and an MLC portion of memory cells. Each of the memory cells can store one or more bits of data (e.g., data blocks) used by the host system 120. Although non-volatile memory components such as NAND type flash memory are described, the memory components 112A to 112N can be based on any other type of memory such as a volatile memory. In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magneto random access memory (MRAM), negative-or (NOR) flash memory, electrically erasable programmable read-only memory (EEPROM), and a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. Furthermore, the memory cells of the memory components 112A to 112N can be grouped as memory pages or data blocks that can refer to a unit of the memory component used to store data.

The memory system controller 115 (hereinafter referred to as “controller”) can communicate with the memory components 112A to 112N to perform operations such as reading data, writing data, or erasing data at the memory components 112A to 112N and other such operations. The controller 115 can include hardware such as one or more integrated circuits and/or discrete components, a buffer memory, or a combination thereof. The controller 115 can be a microcontroller, special purpose logic circuitry (e.g., a field programmable gate array (FPGA), an application specific integrated circuit (ASIC), etc.), or another suitable processor. The controller 115 can include a processor (processing device) 117 configured to execute instructions stored in local memory 119. In the illustrated example, the local memory 119 of the controller 115 includes an embedded memory configured to store instructions for performing various processes, operations, logic flows, and routines that control operation of the memory subsystem 110, including handling communications between the memory subsystem 110 and the host system 120. In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the controller 115, in another embodiment of the present disclosure, a memory subsystem 110 may not include a controller 115, and may instead rely upon external control (e.g., provided by an external host, or by a processor or controller separate from the memory subsystem).

In general, the controller 115 can receive commands or operations from the host system 120 and can convert the commands or operations into instructions or appropriate commands to achieve the desired access to the memory components 112A to 112N. The controller 115 can be responsible for other operations such as wear leveling operations, garbage collection operations, error detection and error-correcting code (ECC) operations, encryption operations, caching operations, and address translations between a logical block address and a physical block address that are associated with the memory components 112A to 112N. The controller 115 can further include host interface circuitry to communicate with the host system 120 via the physical host interface. The host interface circuitry can convert the commands received from the host system into command instructions to access the memory components 112A to 112N as well as convert responses associated with the memory components 112A to 112N into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the controller 115 and decode the address to access the memory components 112A to 112N.

The memory subsystem 110 can be housed in packaging 125. The packaging 125 includes a housing for the integrated circuits of the memory subsystem as well as a physical interface for coupling to a PCB. The embodiments can be utilized in combination with any type of packaging including BGAs, pin grid arrays (PGAs), land grid arrays, carrier chip packaging and similar types of packaging. The embodiments enable the reduction in a number of physical pins, pads, or similar connector types that are needed or that are devoted to testing, debugging, control, configuration, and diagnostics.

The memory subsystem 110 includes wireless component 113 that can enable wireless communication between the memory subsystem 110 and external devices. In some embodiments, the controller 115 includes at least a portion of the wireless component 113. For example, the controller 115 can include a processor 117 (processing device) configured to execute instructions stored in local memory 119 for performing the operations described herein. In some embodiments, the wireless component 113 is separate from but in communication with the controller 115.

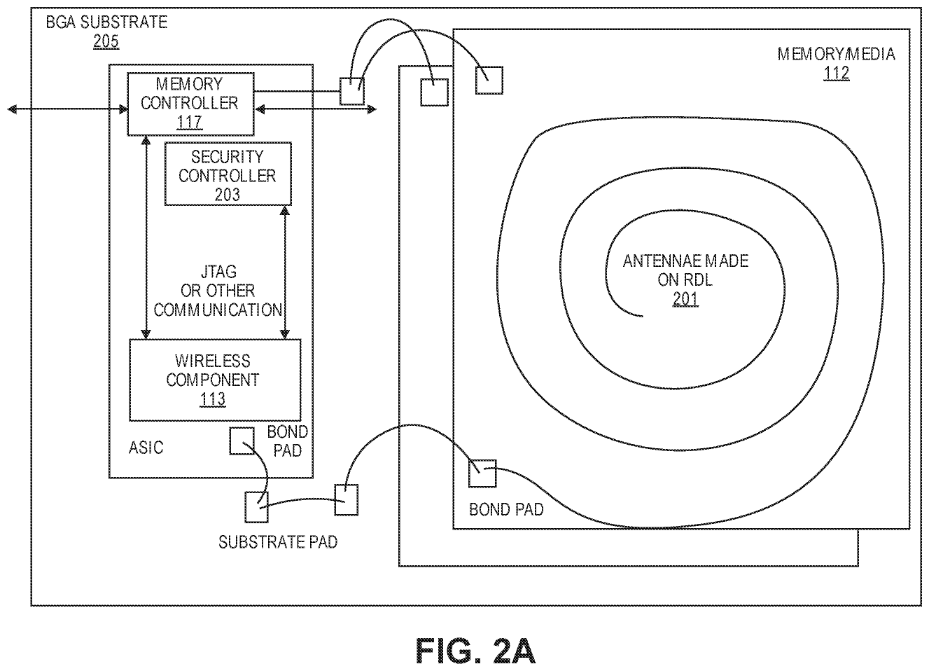

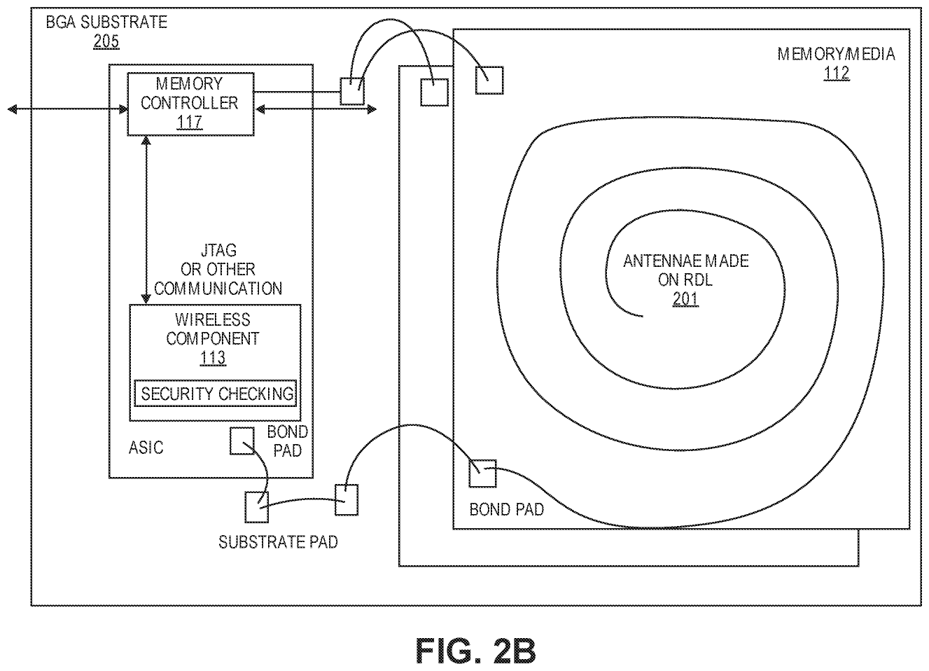

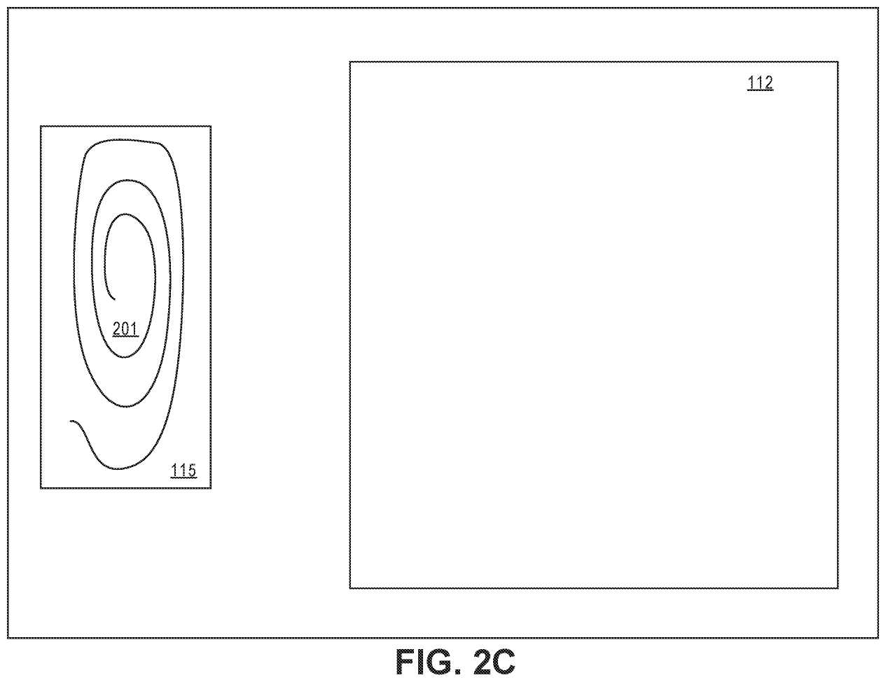

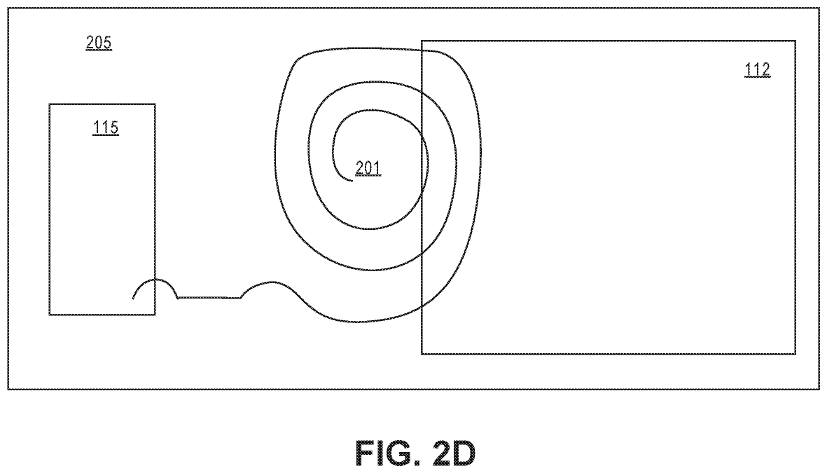

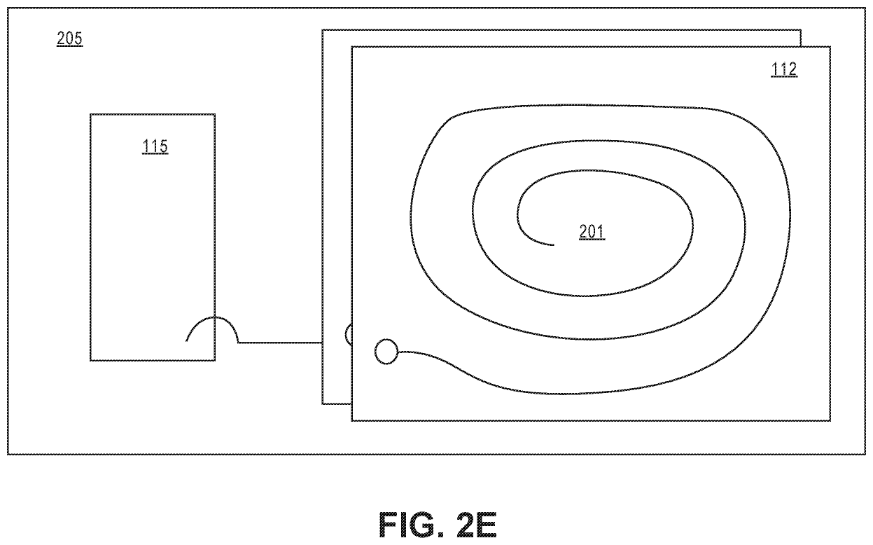

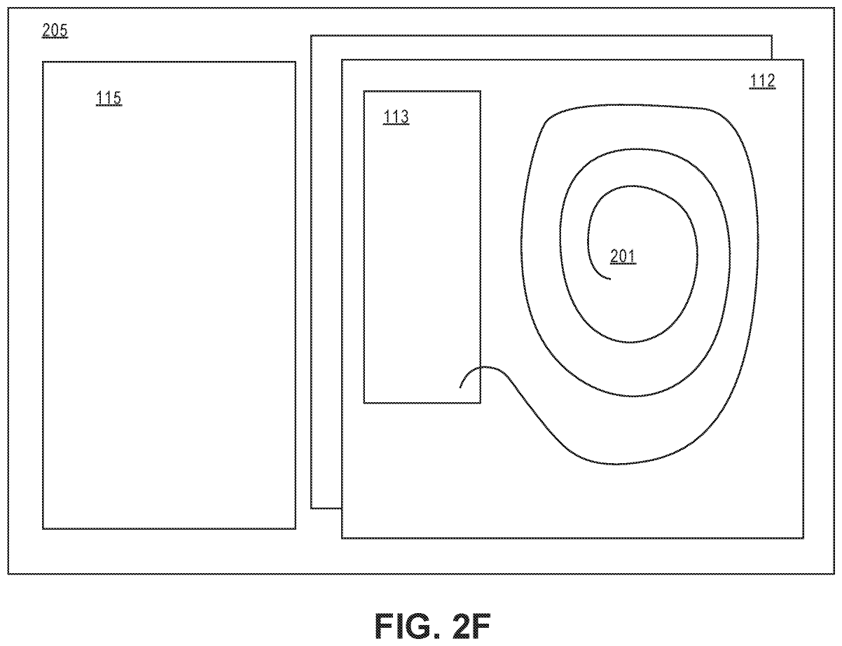

The wireless component 113 can implement a wireless communication protocol. The wireless communication protocol can utilize a near-field short-range wireless communication medium to communicate with devices external to the memory subsystem 110. The wireless component 113 can connect to an antenna 127 that is within the packaging 125 of the memory subsystem 125. In other embodiments, the wireless component 113 can connect to an antenna 129 that is within one or more of the memory components 112A-112N. In a further embodiment, the wireless component 113 can connect to an antenna 131 that is external to the memory sub-system 110 such as an antenna on the PCB of the memory subsystem 110. In some embodiments, multiple antennas in any one or more of these locations can enable communication with multiple external devices or using different wireless mediums and wireless communication protocols. The wireless component 113 can utilize the antenna 127-131 to drive a signal over the wireless medium to communicate with external devices using the wireless protocol. Examples are described herein below with regard to FIGS. 2A-2F.

The wireless component 113 can include a transmission circuit and a receiving circuit. The transmission circuit can transmit data to an external device over the wireless medium. The receiving circuit can receive data from an external device over the wireless medium. The receiving and transmission circuits can support any bandwidth or frequency over the wireless medium that is sufficient to implement debugging, diagnostic, and testing operations.

The wireless component 113 can provide access to internal information of the memory subsystem 110. The internal information can include operational statistics including performance, temperature, internal voltages and similar information. The internal information can further include in-band health information such as serializer/deserializer (SERDES), bit errors, frequency, and similar information. The internal information can also include media health information such as bad bits, bit error rate, lifetime, and similar information. Other internal information of the memory subsystem 110 can include error logs (failure addresses, counts of fails, security failures and attempts and similar information), customer specific data (e.g., serial numbers, secret passwords and keys, carrier information, IMEI data and similar information). The internal information can be used for monitoring memory subsystem 110 health, qualification, and debugging. In some embodiments, where the wireless component 113 is in communication with memory components 112A-112N, then additional information such as user data, error bits, counts of commands sent to the memory, bandwidth and latency information, power and temperature information, repair and in-field repair histories and counts can be made available.

An authentication or security circuit of the wireless component 113 can implement a security protocol to control access to the memory subsystem 110 via the wireless medium. The wireless component 113 can implement a security protocol to control access by external devices to the memory subsystem 110. The wireless component 113 can encrypt communications transmitted over the wireless medium using the wireless protocol. The debugging device and wireless component can utilize any type of encryption process including secret key based encryption algorithms, public key encryption algorithms, or similar encryption algorithms compatible with the wireless protocol implemented by the wireless component 113. In other embodiments, any or all of the security functions can be implemented in a separate security controller.

The antenna 127-131 can be any type of antenna capable of being embedded in the memory subsystem 110. In one embodiment, the antenna 127-131 are wire antennas. The wire antenna can be a dipole antenna, monopole antenna, loop antenna, or similar antenna that can be scaled and constructed in the memory subsystem 110.

In one embodiment, the manufacturer creates a set of antennae 127-131 using traces on a multi-chip module (MCM) substrate or on the PCB. A trace is a layer of conductive metal such as copper that is laid on these substrates to form the antenna. In other embodiments, a manufacturer can apply a redistribution layer (RDL) to a top most die in a stack of dies within a memory subsystem 110. The RDL is a conductive metal layer. The manufacturer can etch or route the RDL to form an antenna structure within the memory subsystem 110. A manufacturing process can select a size of the antenna to conform to Joint Electron Device Engineering Council (JEDEC) standards.

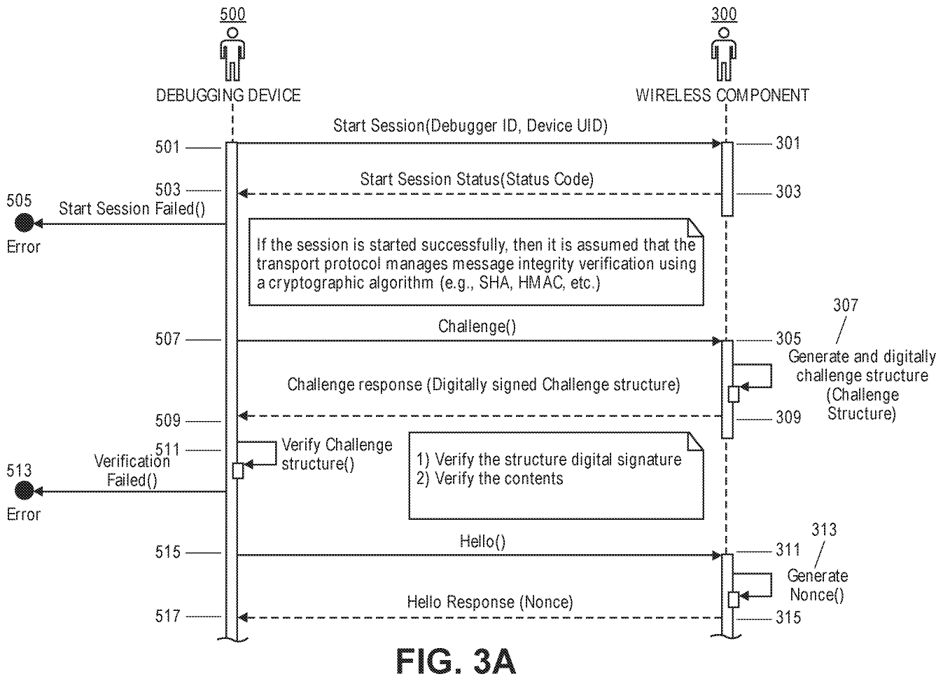

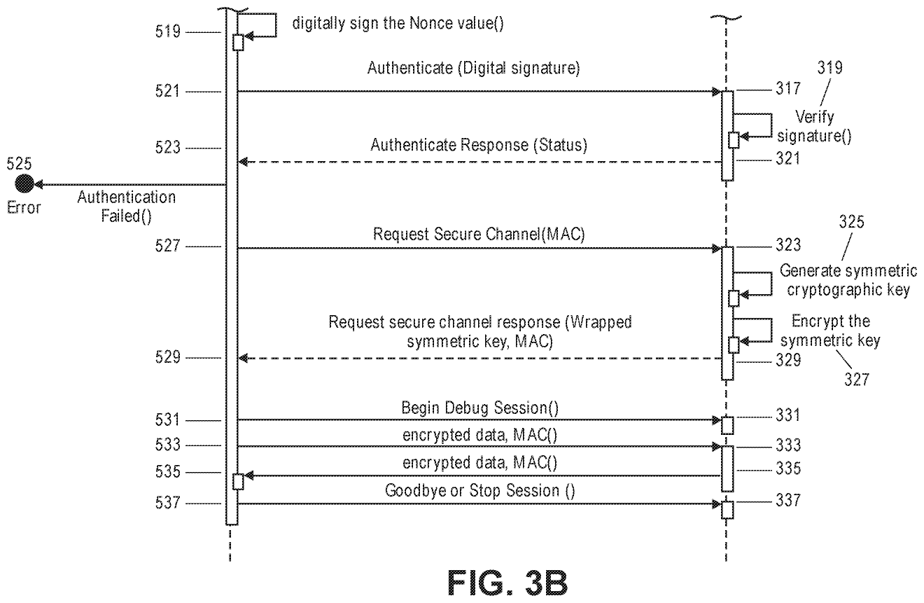

Further details with regards to the operations of the wireless component 113 are described below with regard to FIGS. 3A and 3B.

FIG. 2A is a diagram of an example of an antenna etched in an RDL on a media component. In this example, a security controller 203 is separate from a wireless component 113. As mentioned above, the RDL is a metal layer that utilized for creating input/output pads on integrated circuits. Here, a manufacturer can form the antenna 201 from the metal in the RDL either by etching the antenna from the RDL or by routing the RDL to form an antenna. The antenna 201 can have any layout or design to maximize signal strength or to accommodate signaling. The RDL can be any conductive metal suitable for signaling, such as copper, copper alloys and similar metals.

The antenna 201 can connect to a bond pad in the RDL. The wireless component 113 can connect to the bond pad of the antenna 201 via printed circuits on the substrate 205. The wireless component 113 in this example sits in an application specific integrated circuit (ASIC) mounted on the substrate 205. A bond pad of the ASIC connects (e.g., soldered) to a pad on the substrate 205. The bond pad of the antenna 201 similarly connects to a substrate pad. Circuits on the substrate 205 connect the substrate pads.

FIG. 2B is a diagram of an example of an antenna etched in the RDL on a memory component. The security functions in this example are integrated with a wireless component. Here again, a manufacturer forms an antenna 201 from the RDL either by etching the antenna 201 from the RDL or by routing the RDL to form the antenna 201. The antenna 201 can have any layout or design to maximize signal strength or to accommodate signaling. The RDL can be any conductive metal suitable for signaling, such as copper, copper alloys and similar metals.

The antenna 201 connects to a bond pad in the RDL. The wireless component 113 connects to the bond pad of the antenna 201 via printed circuits on the substrate 205. The wireless component 113 in this example sits in the ASIC. The manufacturer mounts the ASIC on the substrate 205. A bond pad of the ASIC connects (e.g., soldered) to a pad on the substrate 205. The substrate pads connect to one another by printed circuits on the substrate 205. The bond pad of the antenna 201 similarly connect to a substrate pad. In this example, the wireless component 113 integrates the security functions. The wireless component 113 implements the transmission and reception of data over the antenna 201.

FIG. 2C is a diagram of one example of an antenna etched in an RDL on a controller. In this variant, the manufacturer deposits the RDL on the controller 115. As with the prior examples, the manufacturer etches or routes the RDL to form the antenna 201. The antenna 201 can have any design, size, or shape suitable for transmitting and receiving a wireless signal. The wireless component 113 directly connects with the antenna 201 via a port of the packaging of the controller 115.

FIG. 2E is a diagram of one example of an antenna placed on a substrate. The manufacturer prints the antenna 201 or similarly affixes the antenna 201 to the substrate 205. As with prior examples, the antenna 201 can have any design, size, or shape suitable for transmitting a wireless signal. The wireless component 113 connects with the antenna via an I/O pad of the packaging of the controller 115.

FIG. 2F is a diagram of one example of an antenna placed on a memory component and connected with a through silicon via (TSV). In this example, the manufacturer forms the antenna from the RDL either by etching the antenna from the RDL or by routing the RDL to form an antenna. The antenna can have any layout or design to maximize signal strength or to accommodate signaling. The RDL can be any conductive metal suitable for signaling, such as copper, copper alloys and similar metals.

The antenna 201 connects to a TSV formed through the die of the memory component. The wireless component 113 connects to the TSV leading to the antenna 201 via printed circuits on the substrate 205. The wireless component 113 in this example is part of an ASIC mounted on the substrate 205. A bond pad of the ASIC connects (e.g., is soldered) to a pad on the substrate 205. The bond pad of the antenna 201 similarly connects to a substrate pad, which leads to the TSV.

FIG. 2G is a diagram of one example of an antenna on a memory component stack with a controller. In this embodiment, the manufacturer separates the wireless component 113 from the remainder of the controller 115. The manufacturer places the wireless component 113 on the memory component 112. The manufacturer can deposit an RDL on the memory component 112 that is etched or routed to connect the antenna 201 with the wireless component 113. The wireless component 113 can be connected with the controller 115 through a TSV, connections on the substrate 205 or through a similar mechanism.

FIGS. 3A and 3B are a flow diagram of an example method to securely manage communication with an external debugging device in accordance with some embodiments of the present disclosure. Processing logic that can include hardware (e.g., processing device, circuitry, dedicated logic, programmable logic, microcode, hardware of a device, integrated circuit, etc.), software (e.g., instructions run or executed on a processing device), or a combination thereof can implement the example method. In some embodiments, the wireless component 113 of FIG. 1 performs the method 300. A debugging device can perform the complementary method 500. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In one embodiment the secured communication establishment process includes several stages of authentication and verification. The debugging device and the wireless component exchange source/destination information and additional security information. In one embodiment, the debugging device and the wireless component use a message authentication code (MAC) for integrity checking. A MAC can be computed through a number of algorithms (e.g., secure hash algorithm (SHA), hash-based MAC (HMAC), and similar algorithms). The wireless component and the debugging device can confirm that they are talking to a valid (i.e., not cloned) device through a challenge phase. If the debugging device confirms that the wireless component is valid, then the debugging device then authenticates with the wireless component to prove that the debugging device is not a rogue or malicious device. In some embodiments, the debugging device and the wireless component encrypt their communications. After authenticating, the debugging device requests a secure channel. The wireless component generates a symmetric key and then wraps (i.e., encrypts) the symmetric key with a dedicated public key. Only the authorized debugging device can decrypt the symmetric key with a secret private key. Once the debugging device has the symmetric key, all communications between the debugging device and the wireless component will be confidential (e.g., a MAC will still be used for message integrity verification).

In some embodiments, the secured communication between the debugging device and wireless component can be a one to one communication. In some embodiments, the debugging device can discover multiple wireless components in different electronic devices by doing a broadcast (e.g., using a designated identifier such as device a unique identifier (UID)==FFFFFFF) and then collecting device UIDs from the responding wireless components for subsequent Hello, Authenticate, Request secure channel commands.

An example handshake and establishment of a secure communication channel between a debugging device and a wireless component is illustrated in FIGS. 3A and 3B. The debugging device initiates the process by requesting to start a communication session with the wireless component (501). The start session request can include an identifier of the debugging device (i.e., debugger ID) and a unique identifier (UID) for the debugging device. The wireless component receives the start session request (301). In response, the wireless component sends a start session status or similar acknowledgement that initiates the communication session (303). Any type of transport protocol can be used for the initial communication session. The debugging device receives the start session status message along with a status code or similar session information (503). If the start session status message includes a status code indicating a failed communication session start, then the debugging device returns a start session failed or similar error message to any monitoring software (505). If the communication session starts successfully, then the transport protocol can manage message integrity verification using a cryptographic algorithm such as SHA, HMAC and similar encryption protocols.

The process can continue with the debugging device sending a challenge message over a shared wireless medium to the wireless component (507). The wireless component receives this challenge message over the wireless medium (305). The challenge message can have any format, and follow any wireless protocol based on the wireless medium. In some embodiments, the data in the challenge message can form a ‘challenge structure.’ The challenge message can include a device identifier for the debugging device, a unique identifier for the wireless component (device UID) (which can be initially null), a nonce (i.e., a randomly generated number), and a MAC of the debugging device. In response to receiving the challenge message, the wireless component can generate and digitally sign a reply challenge structure (307) using its secret private key (securely provisioned during device manufacturing). The reply challenge structure can include the same set of information as the received challenge structure. The information can include the debugging device identifier, the device UID for the wireless component and a MAC of either the debugging device and/or the wireless component. Once the reply challenge structure is completed, the wireless component can send the challenge structure to the debugging device over the wireless medium (309). The debugging device then receives the challenge structure over the wireless medium (509).

The debugging device verifies the challenge structure received from the wireless component (511). The verification process can compare the digital signature with the other information received from the wireless component to verify the consistency of this information. The verification can include using a public key of the wireless component. If the information does not match, then the verification process fails (513). If the verification process fails, then the process to establish the secure communication exits and an error is returned by the process at the debugging device. If the debugging device determines that the digital signature is valid, then the debugging device examines the contents of the challenge structure. The debugging device may or may not verify the content of the challenge structure. Since the debugging device confirmed the digital signature (only a device with the secret, private key could have successfully created a valid signature), the debugging device has high assurance that the wireless component is genuine (i.e., not a clone).

After the information from the wireless component is verified, the debugging device sends a hello message to the wireless component (515). The debugging device indicates that it would like to establish trust (e.g., authenticate itself) with the wireless component by sending a hello message to the wireless component. The wireless component receives the hello message over the wireless medium (311). The wireless component processes the hello message by generating a nonce value (e.g., a random generated value). The wireless component sends a hello response to the debugging device including the nonce (313 and 315). The nonce is used to support anti-play. The error field can include a value that indicates whether the verification of the hello message information was successful.

The debugging device receives the hello response message over the wireless medium (517). The debugging device checks the error field of the hello response to determine whether the verification of the hello message was successful. The debugging device exits and returns and error if the hello response message includes a value indicating a failed verification of the hello message. If the other hello response message information is correct and the error field does not indicate a verification failure, then the debugging device waits for a further hello response message from the wireless component.

The debugging device creates a digital signature for the wireless component using the provided nonce value (519). The debugging device proves its identity (the debugging device is a trusted device) to the debug device by providing the nonce's signature to the wireless component. The debugging device can send the digitally signed nonce using an authenticate message (521). The wireless component receives the authenticate message over the wireless medium (317). The wireless component verifies the received digitally signed nonce using its associated public key (securely provisioned during device manufacturing). If the signature is valid, then the debugging device is trusted because only an authorized debugging device should have access to the required private key. The debugging device can fail the authentication request if the signature is invalid (signature created using an invalid private key, the data that was signed (nonce) is not the value that the wireless component specified as a response to the hello message or similar cases). To detect man in the middle (MiM) modifications of data exchanged between the debugging device and the wireless component, all non-transport data should be cryptographically integrity checked using a hashed message authentication code (HMAC) or equivalent algorithm. A secure integrity verification algorithm may assume the use of a shared secret (key); the establishment of a shared secret should be unique per device and should be securely provided to the debug device during manufacturing.

The wireless component generates an authenticate response indicating whether the signature is verified. The wireless component sends the authenticate response with this status information over the wireless medium to the debugging device (321). The debugging device receives the authentication response message over the wireless medium (523).

The debugging device checks the status information of the authentication response (525). If the status information indicates a failed authentication at the wireless component, then the debugging device exits the secure communication establishment process and returns an error (525). If the status information indicates a successful authentication at the wireless component, then the debugging device sends a request for a secure channel to the wireless component over the wireless medium (527). The wireless component receives the secure channel request over the wireless medium (323). The wireless component verifies the information of the secure channel request. The wireless component verifies the information by comparing the secure channel request information with previously received security information from the debugging device. If the wireless component verified the requested secure channel message, then the wireless component generates a symmetric encryption key. The wireless component creates an ephemeral, symmetric cryptographic key which the wireless component then encrypts (i.e., wraps) using an asymmetric public wrapping key (325). The wireless component was securely provisioned with this key during device manufacturing. The wireless component encrypts (i.e., wraps) the symmetric key (327). The wireless component responds to the debugging device with the wrapped symmetric encryption key in a request for secure channel response (329).

The debugging device receives the request for secure channel response over the wireless medium (529). Using the associated private key, the debugging device unwraps the symmetric key using its associated private key. All communications between the debugging device and wireless component are now encrypted. The shared symmetric key remains valid until the debugging device is powered off or the wireless component sends a goodbye message, or the session is terminated at the transport layer level.

The debugging device can then decrypt the received symmetric key. The debugging device and wireless component can then use the decrypted symmetric key to encrypt and decrypt the secure channel. The wireless component receives the secured channel over the wireless medium. The debugging device can use the secure channel to initiate a debug or similar session retrieve any combination of diagnostic, performance, test, and/or related data from the wireless component (531). The debugging device can request such data over the secure channel as a memory component operation. The debugging device can encrypt outgoing communication to the wireless component (533). The wireless component receives and decrypts the data (333). The wireless component can similarly encrypt outgoing communication to the debugging device (335). This process can continue until a goodbye, stop, or similar message is sent (537 or 337) is exchanged between the debugging device and the wireless component. The debugging device can locally store debugging, testing, and diagnostics data collected during operation of the memory device.

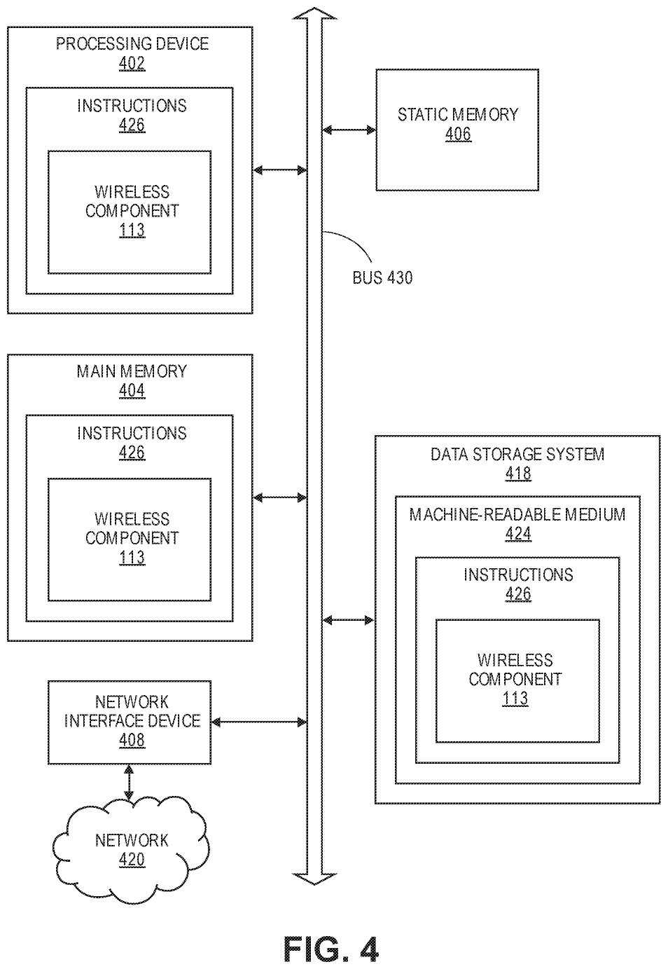

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the wireless component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory subsystem 110 of FIG. 1.

In one embodiment, the instructions 426 include instructions to implement functionality corresponding to aspects of the wireless component (e.g., the wireless component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented method of Figure 300 and similar processes in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method of communication over a wireless medium utilizing an antenna embedded in a memory device executed by a wireless component of the memory device, the method comprising:
authenticating an external device by verifying a credential structure received from the external device over the wireless medium;
responding to a request for a secure communication channel from the external device with a symmetric key;
establishing the secure communication channel with a debugging device over the wireless medium; and
servicing requests from the external device to access data collected on operation of the memory device.

2. The method of claim 1, further comprising:
responding to a challenge message from the external device with a digitally signed challenge structure and media access control address.

3. The method of claim 1, further comprising:
generating a credential structure including a media access control address; and
sending the credential structure to the external device.

4. The method of claim 1, further comprising:
verifying a received media access control address of the external device to verify an identify of the external device.

5. The method of claim 1, further comprising:
encrypting the symmetric key to be sent to the external device.

6. The method of claim 1, further comprising:
driving the secure channel over the wireless medium using the antenna embedded in memory components of the memory device or in a printed circuit board of the memory device.

7. A system comprising:
a memory component; and
a processing device, coupled to the memory component, the processing device comprising a controller and a wireless component configured to establish a secured communication channel with an external device over a wireless medium and to service requests for data collected by the controller for a memory component operation.

8. The system of claim 7, wherein the wireless component is further to authenticate an external device by verifying a credential structure received from the external device over the wireless medium.

9. The system of claim 7, wherein the wireless component comprises a transmitter to drive an antenna to transmit encrypted data over the wireless medium.

10. The system of claim 7, wherein the wireless component comprises a receiver to detect a signal over an antenna to receive the requests from the external device.

11. The system of claim 7, wherein the wireless component is further to respond to a challenge message from the external device with a digitally signed challenge structure and media access control address.

12. The system of claim 7, wherein the wireless component is further to generate a credential structure comprising a media access control address, and to send the credential structure to the external device.

13. The system of claim 7, wherein the wireless component is further to verify a received media access control address of the external device to verify an identify of the external device.

14. The system of claim 7, wherein the wireless component is further to encrypt a symmetric key to be sent to the external device.

15. The system of claim 7, wherein the system comprises an antenna embedded in the memory component or in a printed circuit board of the memory device.

16. A system comprising:
a memory component; and
a controller, coupled to the memory component, to manage access to data in the memory component; and
a wireless component coupled to the controller, the wireless component comprising a receiver to receive requests for data collected by the controller for a memory component operation from an external device over a wireless medium, and a transmitter to transmit requested data to the external device.

17. The system of claim 16, further comprising:
an antenna embedded in the memory component and coupled to the receiver and transmitter.

18. The system of claim 16, further comprising:
an antenna on a printed circuit board of the system, the wireless component and controller mounted on the printed circuit board.

19. The system of claim 16, wherein the wireless component is further to encrypt the requested data using a symmetric key.

20. The system of claim 16, wherein the wireless component authenticates the external device.
